(19) United States
(12) Patent Application Publication
(10) Pub. No.: US 2026/0179501 A1
(43) Pub. Date: Jun. 25, 2026

(54) VIRTUAL COACHING AGENT FOR INSTRUCTING A DRIVER

(71) Applicant: ALLSTATE INSURANCE COMPANY, NORTHBROOK, IL (US)

(72) Inventors: TIMOTHY W GIBSON, BARRINGTON, IL (US); MATEI STROILA, CHICAGO, IL (US)

(21) Appl. No.: 19/416,670

(22) Filed: Dec. 11, 2025

Related U.S. Application Data
(60) Provisional application No. 63/736,926, filed on Dec. 20, 2024.

(51) Int. Cl. G09B 5/06; B60W 50/14

(52) U.S. Cl. CPC G09B 5/065; B60W 50/14; B60W 2540/30

(57) ABSTRACT

Methods, computer readable media, and computing platform to virtually coach a driver of a vehicle are provided. A virtual coaching agent program may control a computing device to receive drive data from a component in communication with the vehicle while a driver is driving the vehicle, the drive data indicative of one or more current characteristics of a drive trip of the vehicle, determine driver behavior of the driver from the drive data, generate, in real time, a coaching response based on the determined driver behavior and deliver, in real-time, the coaching response to the driver within the vehicle via a virtual representation of a coaching agent to promote a driver action.

### CROSS REFERENCE TO RELATED APPLICATIONS

This application claims the benefit of U.S. Provisional Application No. 63/736,926, filed December 20, 2024, the entire contents of which are incorporated by reference.

### FIELD

This invention generally relates to computer systems and computer software that use artificial intelligence. More particularly, aspects of this disclosure provide a tool for virtual coaching of a driver of a vehicle, the tool providing real-time virtual coaching to the driver.

### BACKGROUND

Car accidents are a common cause of injury and damage, and the costs resulting from car accidents can be significant. The frequency of car accidents is especially high for young and/or novice drivers. There is a demand to reduce the number of accidents among this group of drivers. In the United States, many states require mandatory training for new drivers. This training may include attending classes and/or taking a driving course with a certified instructor. Further, in many states, prior to obtaining a driver’s license, users may receive a driving permit that allows them to drive if another person with a valid driver’s license is in the vehicle. However, numerous studies show that the riskiest driving period for young drivers is immediately after getting a license and becoming an independent driver when another licensed driver in the vehicle is not required. The same studies show that continuous parental (or other driving-experienced adult) involvement through coaching and monitoring is an effective way to reduce the risk of accidents.

### SUMMARY

Systems and methods for virtual coaching of a driver of a vehicle are provided. With these systems and methods, using samples of voice and images of a coaching agent, one can generate audio, video, and/or three-dimensional holograms that can deliver in real time in-vehicle coaching messages. The simulated presence of the coaching agent in the vehicle can help reduce the number of risky driving maneuvers.

The present disclosure provides, in one aspect, a computing platform that includes a processor, a communication interface communicatively coupled to the processor, and memory storing computer-readable instructions that, when executed by the processor, cause the computing platform to: receive drive data from a component in communication with the vehicle while a driver is driving the vehicle, the drive data indicative of one or more current characteristics of a drive trip of the vehicle; determine driver behavior of the driver from the drive data; generate, in real time, a coaching response based on the determined driver behavior; anddeliver, in real-time, the coaching response to the driver within the vehicle via a virtual representation of a coaching agent to promote a driver action.

The present disclosure provides, in another aspect, a computer-implemented method to virtually coach a driver of a vehicle includes receiving drive data from a component in communication with the vehicle while a driver is driving the vehicle, the drive data indicative of one or more current characteristics of a drive trip of the vehicle; determining driver behavior of the driver from the drive data; generating, in real time, a coaching response based on the determined driver behavior; anddelivering, in real-time, the coaching response to the driver within the vehicle via a virtual representation of a coaching agent to promote a driver action.

The present disclosure provides, in another aspect, one or more non-transitory computer-readable media that includes one or more non-transitory computer-readable media storing instructions that, when executed by a computing platform comprising at least one processor, a communication interface, and memory, cause the computing platform to: receive drive data from a component in communication with the vehicle while a driver is driving the vehicle, the drive data indicative of one or more current characteristics of a drive trip of the vehicle; determine driver behavior of the driver from the drive data; generate, in real time, a coaching response based on the determined driver behavior; anddeliver, in real-time, the coaching response to the driver within the vehicle via a virtual representation of a coaching agent to promote a driver action.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals.

FIG. 1 illustrates an example operating environment for implementing a virtual coaching system and methods as described herein.

FIG. 2 illustrates a block diagram of a computing device that can implement virtual coaching systems and methods as described herein.

FIG. 3 illustrates a block diagram of an embodiment of a virtual coaching agent engine as represented in FIG. 2.

FIG. 4 illustrates a process flow diagram of a computer-implemented method to virtually coach a driver of a vehicle.

FIG. 5 illustrates an example graphical user interface for a virtual coaching agent application according to one embodiment.

### DETAILED DESCRIPTION

Systems and methods for virtual coaching of a driver of a vehicle are provided. Through the systems and methods provided herein a novice driver can receive coaching from a virtual coaching agent during a period of time after receiving a driving license when another person is not required to be in the vehicle. In other instances, an elderly driver can receive coaching from the virtual coaching agent when his/her driving skills are not as sharp as in the past. In some cases, the virtual coaching agent can be a virtual representation of a real person that is familiar to the driver such as a parent, a teacher, a favorite uncle, etc. In other cases, the virtual coaching agent can be a virtual representation, e.g., an avatar, of a person or non-living character. Having a virtual coaching presence in the vehicle can help keep the driver vigilant about performing driving skills correctly and confidently in order to stay safe in the vehicle and keep the driving environment safer for other drivers. Safe driving also includes the additional benefits of keeping insurance premiums lower for the driver.

It is noted that various connections between elements are discussed in the following description. It is noted that these connections are general and, unless specified otherwise, may be direct or indirect, wired or wireless, and that the specification is not intended to be limiting in this respect.

The systems and methods described herein may utilize generative artificial intelligence and machine learning techniques. As described in more detail below, the generative artificial intelligence techniques may be used to analyze large amounts of data and generate outputs based to specific prompts. The artificial intelligence techniques can use machine learning models trained with a training set of data. The data may be historical data, such as data gathered during one or more processes described herein. The machine learning models may include or may be included in a computing device, such as a user device or vehicle computing system.

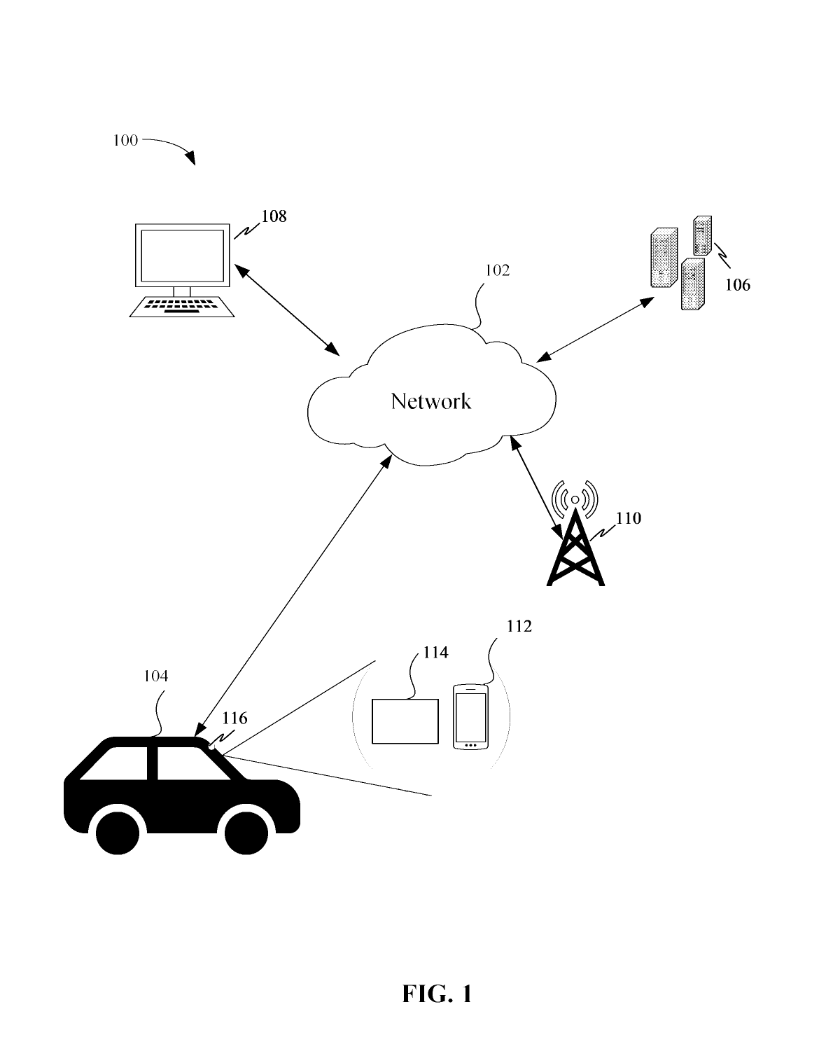

FIG. 1 illustrates an example operating environment for implementing a virtual coaching system and methods as described herein. Referring to FIG. 1, operating environment 100 includes a network 102, an administrative computing device 108, servers 106, one or more access points 110, and a vehicle 104. The network 102 can be configured to connect computing devices within or associated with vehicle 104. Network 102 can be any type of network including a local area network (LAN) or a wide area network (WAN). Network 102 can include a cellular network and its components, such as base stations, cell towers, etc. In some cases, the network 104 can provide a path for connecting to application servers 106. Operating environment 100 can include access points 110 that extend the network to reach mobile computing devices. The access points 110 can include cellular network components, global positioning system components, and other wireless access components (e.g., routers) for connecting computing devices within or associated with the vehicle 104.

While the vehicle 104 is shown in FIG. 1 as a car, the vehicle can be a truck, bus, recreational vehicle or other vehicle for which sensor data can be collected. Vehicle 104 can include one or more sensing components 116. Most vehicles today include sensing components that collect drive data which can be any data related to a drive trip of the vehicle 104. For example, the drive data can be vehicle telematics data which describes multiple aspects of the vehicle’s operation and how the vehicle is being driven. For example, the vehicle telematics data may include global positioning system (GPS) coordinates to allow the location of the automobile to be tracked.

In order to gather drive data, sensing components 116 can be embodied as sensors positioned within or on the vehicle 104 or exist on a computing device, such a driver’s mobile device 112, residing within the vehicle 104. For example, sensing components 116 can detect and store data corresponding to the vehicle’s speed, distances driven, rates of acceleration or braking, geographic location, and/or specific instances of sudden acceleration, braking, and swerving. Sensing components 116 can also detect and store data received from the vehicle’s internal systems, such as impact to the body of the vehicle 104, air bag deployment, headlights usage, brake light operation, door(s) opening and closing, door locking and unlocking, cruise control usage, hazard lights usage, windshield wiper usage, horn usage, turn signal usage, seat belt usage, phone and radio usage within the vehicle, maintenance performed on the vehicle, and other data collected by the vehicle’s computer systems.

Additionally, drive data can include data describing the driving conditions of the vehicle 104. Sensing components 116 can detect and store conditions external to the vehicle such as external temperature, rain, (e.g., using a rain sensor on the windshield), light levels, and sun position for driver visibility. Sensing components 116 can also detect, and store data related to moving violations and the observance of traffic signals and signs by the vehicle 104. Furthermore, internal cameras in the sensing components, or dash cameras installed on the dashboard of the vehicle 140, can detect conditions such as number of passengers in the vehicle 104 and other sources of distractions (e.g., pets, phone usage, unsecured objects in the vehicle). While many types of sensing components have been described herein, other sensing components detecting and storing additional data about the vehicle’s operation and driving conditions can also be collected as drive data.

One or more computing devices can be located within the vehicle 104. For example, vehicle 104 can include a driver computing device 112 and a vehicle computing device 114. The driver computing device 112 and the vehicle computing device 114 are shown for exemplary purposes only. Of course, more or less computing devices can be within or associated with the vehicle 104. Through the network 102, the driver computing device 112, e.g., a driver mobile device, and vehicle computing device 114, e.g., an on-board diagnostic system, may communicate with the application servers 106 to retrieve information such as driving statistics, maps, time of day, weather information, traffic information, position information, software updates, etc. The driver mobile device 112 may be positioned within the vehicle 104, e.g., on a center console or mounted on a flat surface so that its display can be seen by the driver but is not obstructing the view of the driving surface and external environment. The vehicle computing device 114 typically includes a display screen on the center console. Software applications may be installed on and execute on the driver mobile device 112.

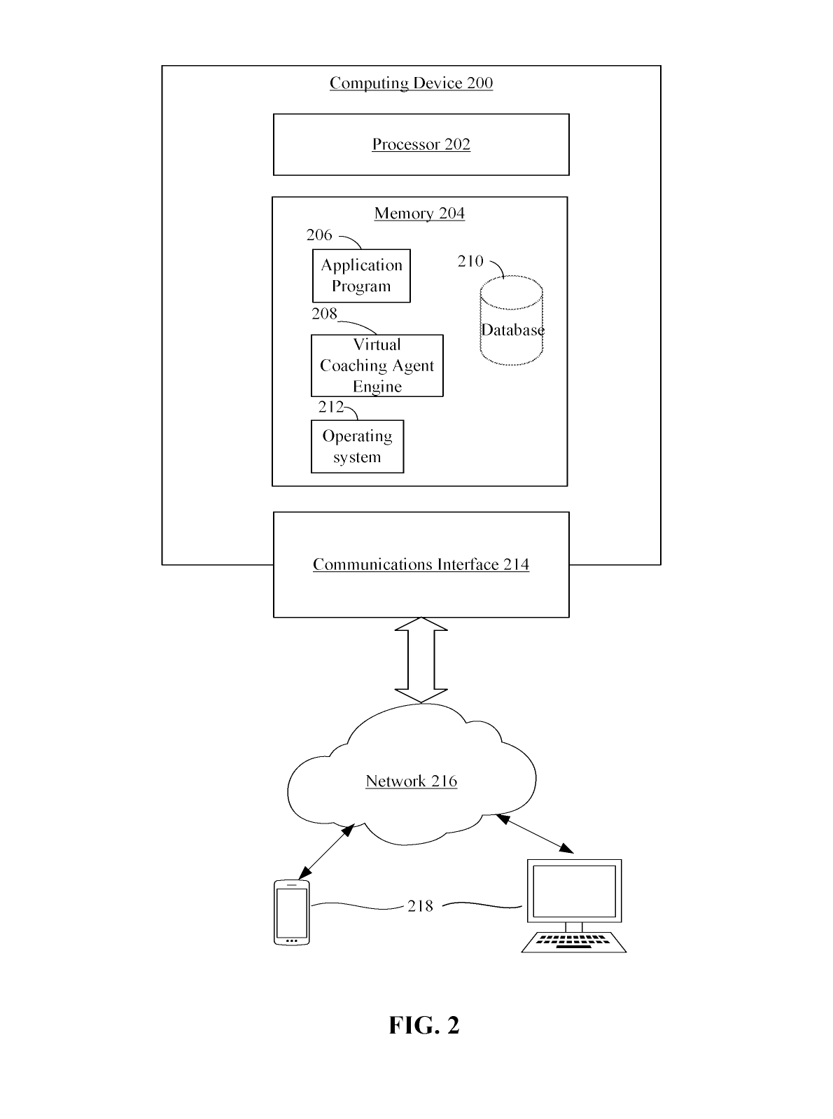

FIG. 2 illustrates a block diagram of an example computing device that can implement virtual coaching agent systems and methods as described herein. Referring to FIG. 2, the computing device 200 can be similar to any available computing device, such as a personal computer (e.g., a desktop computer), server, laptop computer, notebook, tablet, smartphone, etc. The computing device 200 can include one or more processors 202, memory 204, and communications interface 214. A data bus may interconnect processors 202, memory 204, and communications interface 214. The communications interface 214 can be a network interface configured to support communication between the computing device 200 and one or more networks 216. Through the network 216, the computing device 200 may communicate with one or more remote computing devices 218 such as laptops, notebooks, smart-phones, personal computers, servers, etc.

The memory 204 can include operating system 212 and one or more application programs 206 having instructions that when executed by processor 202 cause the computing device 200 to perform one or more functions described herein and a database 210 that stores information which can be used by the application programs 206, processor 202, and operating system (OS) 212. In addition, the memory 204 can include virtual coaching agent engine 208. Application program(s) 206 can perform methods executing instructions of a virtual coaching agent program described herein.

The communications interface 214 can also include a user interface. The user interface may include user interface software and associated software (e.g., for graphics chips and input devices) executed by the OS 212 in support of the various user input and output devices. The associated software assists the OS 212 in communicating user interface hardware events to application programs using defined mechanisms. The user interface software may support a graphical user interface, a natural user interface, or any other type of user interface. The user interface may also include output devices such as a display screen (s), speakers, haptic devices for tactile feedback, and other types of output devices. In certain cases, input and output devices may be combined in a single device, such as a touchscreen display which both depicts images and receives touch gesture from the user.

In an embodiment, virtual coaching agent engine 208 comprises a processing unit that can produce a scripted coaching response to current driver behavior. Current driver behavior can be determined by drive events informed by sensors 116 coupled to the vehicle 104, for example. The processing unit can map the determined driver behavior to an appropriate coaching response. For example, when the driver is speeding, the appropriate coaching response can be “Slow down.”

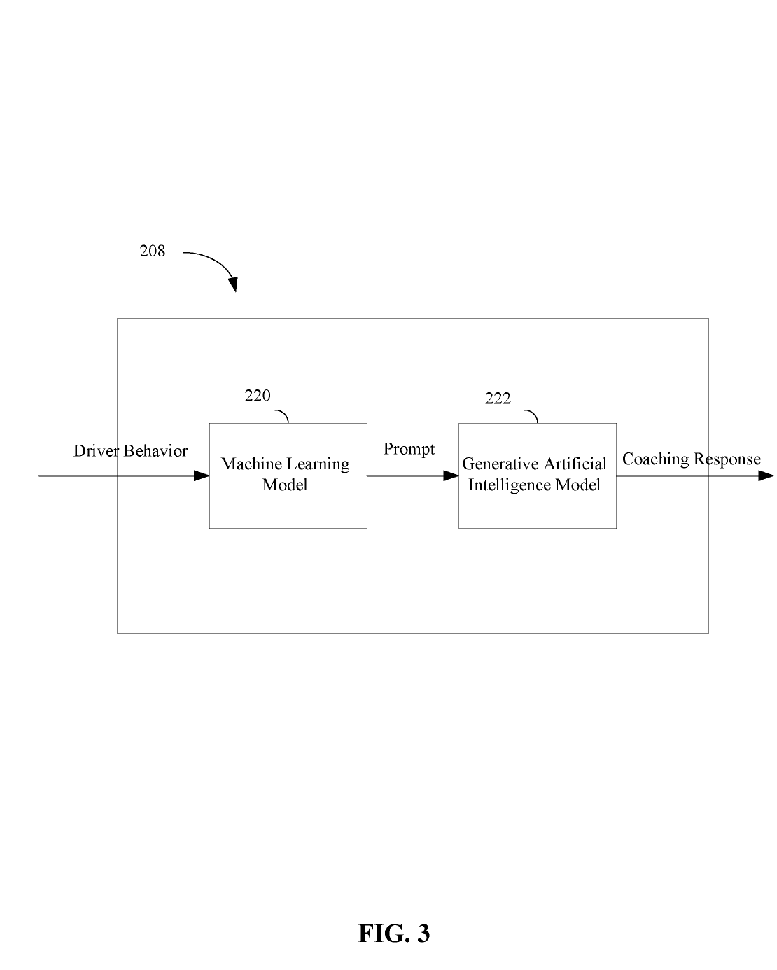

In another embodiment, the virtual coaching agent engine 208 can include artificial intelligence models. FIG. 3 illustrates a block diagram of an embodiment of a virtual coaching agent engine as represented in FIG. 2. Referring to FIG. 3, virtual coaching agent engine 208 includes a machine learning model 220 and a generative artificial intelligence model 222. In some cases, the machine learning model 220 can be multiple machine learning models. The machine learning model 220 can receive as input current driver behavior as shown in FIG. 3. From the driver behavior, the machine learning model 220 can generate a prompt describing a coaching message for the driver of vehicle 104. The prompt describing the coaching message for the driver is input into the generative AI model 222 to express the coaching message based on one or more characteristics of the virtual coaching agent such as a verbal characteristic and/or a visual characteristic. The generative AI model 222 can map the given prompt to verbal and/or visual coaching responses of the virtual coaching agent.

Computing device 200 can train both the machine learning model 220 and the generative AI model 222. The machine learning model 220 can be trained on driver behaviors to determine appropriate coaching responses for the driver behaviors. The driver behaviors can be those determined and stored from the particular driver of the vehicle or other general driving behaviors. Additionally, the machine learning model 220 can be trained on ‘optimal’ driver behaviors, e.g., driving behaviors that fall within driving laws and rules of the drive trip location and/or that are deemed safe and not prone to cause accidents. The generative AI model 222 can be trained on characteristics of a real person or character to generate a plausible coaching response that is representative of the real person or character.

Computing device 200 can train the generative artificial intelligence model 222 on characteristics of the real person, for example, to generate a plausible coaching response that is representative of real person. For example, the generative artificial intelligence model 222 can be trained on the characteristics of the driver’s mother so that the coaching responses are representative of the driver’s mother. Once the artificial intelligence model 222 demonstrates that it can accurately operate according to a defined standard (e.g., the coaching response accurately depicts the characteristics of the real person), it can be deployed for use with the virtual coaching agent system and methods described herein.

In some cases, the generative AI model 222 is a large language model trained with voice characteristics of a real person. For example, the large language model can be trained with the input of text and a voice sample of the real person to generate a synthesized voice of the real person. Prior to the training, the real person would produce a voice sample for the virtual coaching agent system on the application program on a mobile device. The application program can include a training module that collects voice and/or image data from the real person. For example, the voice sample can include the parent reading from a script presented on the app. For example, the parent can say “The quick brown fox jumped over the lazy brown dog.” The synthesized voice can closely resemble that of the real person, such as a parent or another real adult person known to the driver, with the result that there is a virtual presence of the real person in the vehicle and the driver feels he/she is receiving personalized coaching. Generative AI technologies such as Variational Autoencoders, Generative Adversarial Networks and Large Language Models can accurately render actual likenesses of real people. For example, the coaching responses can be synthesized voices of a parent that can include accurate voice inflection and tone of the parent and can communicate urgency.

In other cases, the generative artificial intelligence model 222 is a large language model trained with images of a person. Prior to the training, the real person would consent to having images of himself/herself used for the virtual coaching agent for the driver or the real person would take an image of himself/herself to be used by the virtual coaching agent engine. The images can be input into the application model on a mobile device. The generative AI model 222 can use the images to create a two-dimensional virtual representation of the virtual coaching agent. In some cases, the AI model 222 can use a neural radiance field such that it is trained with the two-dimensional images of the person to create a three-dimensional representation such as a hologram.

The machine learning model 220 may utilize one or more tools, or one or more models such as, for example, a linear regression, a decision tree, a support vector machine, a random forest, a k-means algorithm, gradient boosting algorithms, gradient boosted tree model algorithm, dimensionality reduction algorithms, and the like. The machine learning model 220 may be trained via supervised learning techniques, based on historical data, to determine the appropriate coaching responses. Once the machine learning model 220 demonstrates that it can accurately operate according to a defined standard (e.g., the prompt accurately reflects an appropriate coaching response for the determined driver behavior), it can be deployed for use with the virtual coaching agent system and methods described herein.

The generative AI model 222 can include a large language model that utilizes a neural network and/or other machine learning algorithms. The generative AI model 22 can analyze data, e.g., the prompt, to generate a coaching response with characteristics of the real person. In some cases, the coaching response can be a verbal response of the real person. In other cases, the coaching response can be a visual representation of the real person paired with a verbal response of the real person or without a verbal response of the real person. For example, a visual response of the driver’s mother can indicate with her hands a ‘stop’ signal to promote a driver to stop at an upcoming stop sign, for example.

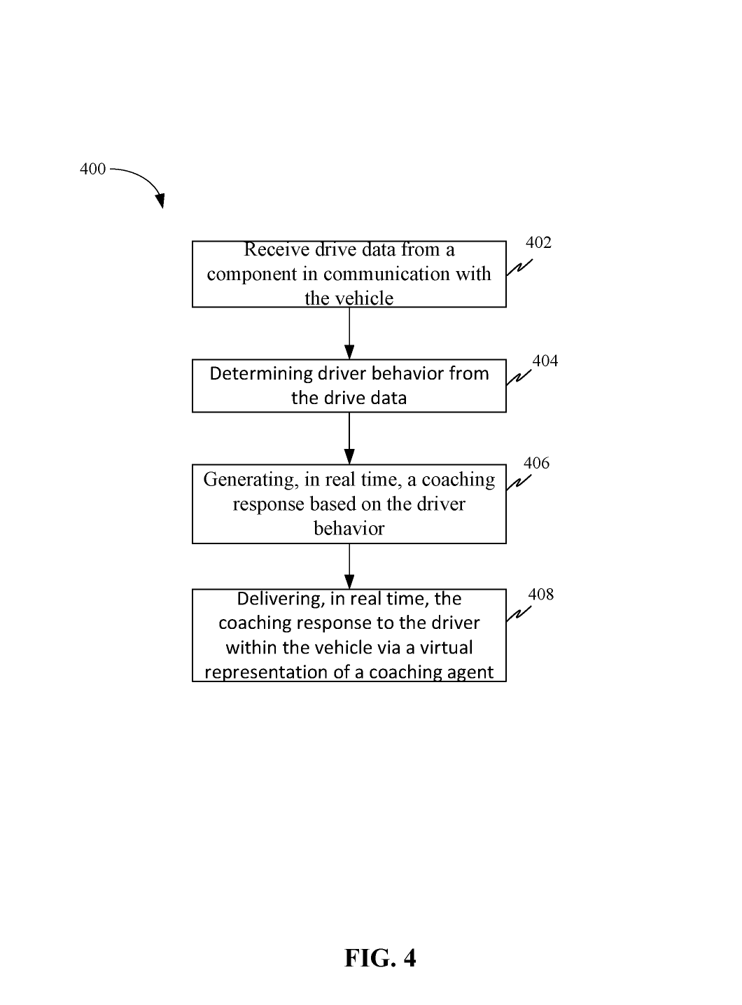

FIG. 4 illustrates a flow diagram of a computer-implemented method to virtually coach a driver of a vehicle. Method 400 can be performed by a computing device such as computing devices 112, 114, and 200 described with respect to FIG. 1 and FIG. 2. More specifically, FIG. 4 illustrates a plurality of steps a computing device may perform to provide a driver with virtual coaching information that the driver can use to improve and/or reinforce driving skills while the driver is driving. In some cases, the method 400 can produce a virtual presence of a person, e.g., a coaching agent, in the vehicle to provide virtual coaching based on the driver’s own driving behavior.

Referring to FIG. 4, the method 400 includes receiving (402) drive data from a component in communication with the vehicle while the driver is driving the vehicle, determining (404) driver behavior from the drive data, generating (406), in real-time, a coaching response based on the driver behavior, and delivering (408) the coaching response to the driver within the vehicle via a virtual representation of a real person.

Method 400 includes receiving (402) drive data captured from components in communication with the vehicle while the driver is driving the vehicle. The drive data is indicative of the current characteristics of a drive trip of the vehicle. In some cases, the drive data can be sensed data, as described previously, captured from one or more sensors coupled to the vehicle while the driver is driving the vehicle. The one or more sensors can be directly coupled to the vehicle as well as sensors from one or more mobile computing devices within or associated with the vehicle. Characteristics of the drive trip can include current weather conditions, road conditions, traffic conditions, braking data, turning data, speed data, acceleration/deceleration data, vehicle operation data, driver conditions (driver state/mood/alertness), vehicle telematics data, etc.

Method 400 further includes determining (404) driver behavior from the drive data. The drive behavior can be determined from drive events informed by the sensors. For example, drive events can include driving maneuvers, driving characteristics, and driving conditions. In some cases, driver behavior can be determined by comparing parameters of the drive event, e.g., a braking event, to a threshold or a range. The threshold or range can include standards for the drive event. The determined drive behavior can be stored in the memory 204 to be used for further assessment and possibly be used for future training of the machine learning model.

Driving maneuvers can include braking, turning, accelerating, decelerating, swerving, changing lanes, parking tailgating, etc. As a detailed example, a braking event can be detected based deceleration data detected from an accelerometer. Algorithms can be used to determine the braking event from the deceleration data. For example, a braking event can be detected when the deceleration data exceeds a threshold, e.g., the vehicle speed decreased by 20 mph in a certain amount of time, and the vehicle’s speed goes down to a minimum level, such as 1 mph. The driver behavior, in this example, is that the driver is hard braking.

Driving characteristics can include driving speed, alertness of the driver, distracted driving, etc. As a simple example, it can be determined that the driver is speeding (driver behavior) based on the speed of the vehicle and the posted speed limit for the driving location. Alertness of the driver as well as distracted driving can be determined from cameras located within the vehicle.

Driving conditions can include the time of day, weather, road conditions, etc. Driving conditions can be obtained by different means. External sensors can sense environmental conditions, e.g., solar detectors can detect sun exposure or and rain sensors can detect rain. However, weather data can also be obtained from satellite data communicated to the vehicle via the computing devices 112, 114, 200.

Method 400 further includes generating (406), in real time, a coaching response based on the determined driver behavior. In some cases, the coaching response can be generated utilizing at least one of a machine learning model trained or a generative AI model. The coaching response can include characteristics of a real person as described above to create a virtual representation of the coaching agent.

In many cases, the virtual coaching from the coaching agent is instructive in order to promote a driver action. For example, if a coaching response states that the driver is driving above the speed limit, the implication is that the desired driver action would be to slow the speed of the vehicle.

In some cases, the coaching responses can include both positive and negative feedback. For example, when the driver goes over a speed limit by a determined threshold, e.g., 5 mph, the coaching response can include a verbal response of “you’re going too fast” or a visual image of the parent with a scowl and shaking her/his head back and forth. On the other hand, when the driver is driving the speed limit on the way home from school through a neighborhood, the coaching response can include an affirming verbal response of, “Thanks for driving the speed limit through the neighborhood” or a visual image of the parent smiling and shaking her/his head up and down. Additionally, the coaching responses can include consequences for not performing the implied desired driver action.

In some cases, the coaching responses can include responses to different driving conditions. For example, if the drive data indicates that an accident has occurred, e.g., using motion sensors on the mobile computing device 112, for example, the virtual coaching agent can deliver a coaching response and, in some cases send an alert, until a parent or police officer can be called or can get to the scene of the accident. The coaching response can include reminders of things to do, e.g., call the police, with a sympathetic and caring voice response.

Method 400 further includes delivering (408) the coaching response to the driver within the vehicle 104 via a virtual representation of a real person. The coaching response can be delivered to the driver through one of the computing devices in the vehicle. For example, the coaching response can be delivered via a vehicle speaker system or a vehicle display on driver computing device 112 and/or 114. In some cases, the coaching message can be delivered via a synthesized voice of the real person by the vehicle speaker system. In other cases, the coaching message can be delivered via a three-dimensional representation of the real person. The three-dimensional representation can be a video representation of the real person displayed on the computing device’s display. In some cases, the three-dimensional representation of the real person can be a holographic image displayed on a spatial display (special holographic display) installed within the vehicle.

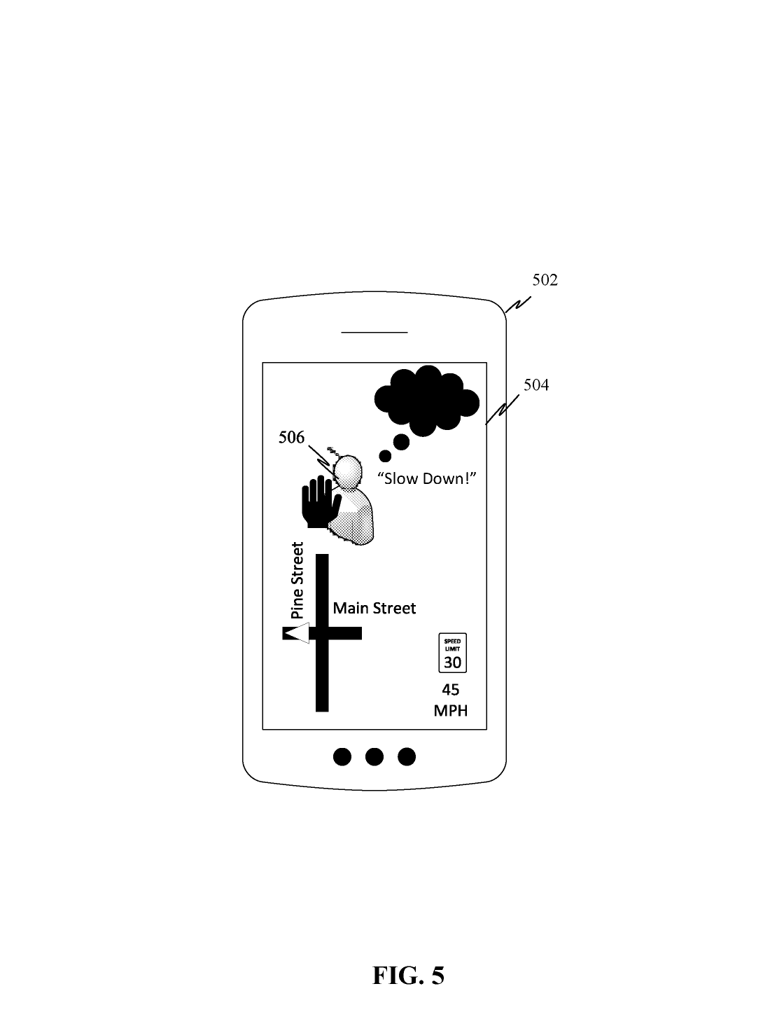

FIG. 5 illustrates an example graphical user interface for a virtual coaching agent application according to one embodiment. Referring to FIG. 5, computing device 502, e.g., a mobile computing device 112 located within vehicle 104, can display through graphical user interface 504, in response to the driver speeding as in the illustrated example (driving 45 MPH in a 30MPH speed limit zone), an avatar 506 of a person or non-living character, saying “Slow Down!” with a raised hand. Graphical user interface 504 can also include a map view of the current car position, the speed limit number, and the current vehicle speed.

In some cases, the virtual coaching agent program can be interactive so that the driver can elicit coaching responses from verbal input or respond in kind to the coaching responses. For example, the driver can verbally respond that he/she has performed the implied desired driver action in response to the coaching response. The method 400 can then further include sending an alert to the remote computing device 218 of a real person (that the coaching agent represents) via the network 216 to include the verbal response of the driver in response to the coaching response. For example, if the coaching response from the coaching agent, e.g., representing Mom/Dad, includes “Slow down!”, the driver can respond with verbal input “Mom/Dad, I’ve slowed down” that can be sent to Mom/Dad’s mobile phone 218 via the network 216. Mom/Dad can access the verbal response via an application program installed on her/his mobile phone 218.

In some cases, the virtual coaching agent program can include a digital twin of the real person that the coaching agent represents. The digital twin can use one or more adaptive learning methods to learn preferences of the real person such that the digital twin can operate as a proxy for the real person when the driver presents the virtual coaching agent program with a prompt for an interactive conversation.

The virtual agent program can store coaching information gathered during a drive trip. In some cases, the method 400 can include aggregating the stored coaching information and producing a report for the drive trip. The report for the drive trip can be accessed via the computing devices 112, 114, 200 or the remote computing devices 218. The report can include various statistics including the content of the coaching responses issued during the drive trip, for example as well as feedback regarding the aggregated coaching information. The feedback on the report can also include driver performance improvement on certain skills or driving skills that are not improving so that remediation with additional skills training may be needed. Additionally, the stored coaching information can include along with the coaching responses, the driver behavior associated with the coaching response before and after the coaching response is delivered to the driver. Driving behavior can be determined, as previously described, immediately after, e.g., several seconds to a minute after, or longer, e.g., several minutes, after the coaching response has been delivered. Using the driver behavior before and after the issued coaching response can then be used to further train the generative AI model (also known as reinforcement training) to improve the coaching response effectiveness with the result that future coaching responses can become more personalized.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A computing platform, comprising:
a processor;
a communication interface communicatively coupled to the processor; and
memory storing computer-readable instructions that, when executed by the processor, cause the computing apparatus to:
receive drive data from a component in communication with the vehicle while a driver is driving the vehicle, the drive data indicative of one or more current characteristics of a drive trip of the vehicle;
determine driver behavior of the driver from the drive data;
generate, in real time, a coaching response based on the determined driver behavior; and
deliver, in real-time, the coaching response to the driver within the vehicle via a virtual representation of a coaching agent to promote a driver action.

2. The computer platform as claimed in claim 1, wherein the coaching agent is a real person.

3. The computer platform as claimed in claim 1, wherein the coaching agent is a character that includes an avatar of the character.

4. The computer platform as claimed in claim 1, wherein the coaching agent is a digital twin of a real person.

5. A computer-implemented method to virtually coach a driver of a vehicle, comprising:
receiving drive data from a component in communication with the vehicle while a driver is driving the vehicle, the drive data indicative of one or more current characteristics of a drive trip of the vehicle;
determining driver behavior of the driver from the drive data;
generating, in real time, a coaching response based on the determined driver behavior; and
delivering, in real-time, the coaching response to the driver within the vehicle via a virtual representation of a coaching agent to promote a driver action.

6. The method as claimed in claim 5, wherein generating, in real-time, the coaching response based on the determined driver behavior includes generating, by at least one of a machine learning model or a generative artificial intelligence (AI) model, the coaching response to include a characteristic of the virtual coaching agent.

7. The method as claimed in claim 6, wherein the coaching response is generated by the generative AI model trained with one or more characteristics of a real person.

8. The method as claimed in claim 7, wherein the generative AI model is trained with voice characteristics of the real person.

9. The method as claimed in claim 7, wherein the generative AI model is trained with two-dimensional images of the real person.

10. The method as claimed in claim 5, wherein delivering the coaching response to the driver within the vehicle includes delivering the coaching response via a synthesized voice of a real person.

11. The method as claimed in claim 5, wherein delivering the coaching response to the driver within the vehicle includes delivering the coaching response via a three-dimensional representation of a real person.

12. The computer-implemented method as claimed in claim 5, wherein receiving drive data from a component in communication with the vehicle while the driver is driving the vehicle comprises receiving sensed data captured from sensors coupled to the vehicle.

13. The computer-implemented method as claimed in claim 5, wherein the coaching response is interactive so that the driver communicates a verbal response in response to the coaching response.

14. The computer-implemented method as claimed in claim 13, wherein the coaching agent is a real person.

15. The computer-implemented method as claimed in claim 14, further comprising sending an alert to a remote computing device of the real person via a network, wherein the alert includes the verbal response from the driver.

16. The computer-implemented method as claimed in claim 5, wherein the coaching agent is a digital twin of a real person.

17. The computer-implemented method as claimed in claim 5, further comprising storing the coaching response as coaching information during the drive trip.

18. The computer-implemented method as claimed in claim 17, further comprising aggregating the stored coaching information to produce a report for the drive trip.

19. The computer-implemented method as claimed in claim 18, wherein the aggregated stored coaching information includes the coaching response, the determined driver behavior, the coaching response, and driver behavior after the coaching response is delivered.

20. One or more non-transitory computer-readable media storing instructions that, when executed by a computing platform comprising at least one processor, a communication interface, and memory, cause the computing platform to:
receive drive data from a component in communication with the vehicle while a driver is driving the vehicle, the drive data indicative of one or more current characteristics of a drive trip of the vehicle;
determine driver behavior of the driver from the drive data;
generate, in real time, a coaching response based on the determined driver behavior; and
deliver, in real-time, the coaching response to the driver within the vehicle via a virtual representation of a coaching agent to promote a driver action.
